(19) United States
(12) Patent Application Publication
(10) Pub. No.: US 2018/0014664 A1
(43) Pub. Date: Jan. 18, 2018

(54) PICTURE FRAME WITH DESCRIPTIVE BORDERS

(71) Applicant: Professional Global Traders, Inc., Camden, DE (US)

(72) Inventor: Hatem A. Tabo, Santa Clara, CA (US)

(21) Appl. No.: 15/209,378

(22) Filed: Jul. 13, 2016

(51) Int. Cl. A47G 1/06; G09D 3/02

(52) U.S. Cl. CPC A47G 1/0616; A47G 1/065; G09D 3/02

(57) ABSTRACT

This disclosure concerns a picture frame. The picture frame includes a picture frame body having a picture window disposed in the center of the picture frame body. A plurality of descriptive borders is disposed at the periphery of the picture frame. The plurality of descriptive borders include indicia for indicating a name, a year of birth, a blood type, a weight, a height, a date of birth, and a horoscope sign. A plurality of adjustable markers are provided to be used with the descriptive borders to provide the information relating to the subject whose picture is displayed in the picture window.

### TECHNICAL FIELD

The invention generally relates to a picture frame, and more particularly, to a picture frame including multiple adjustable indicia.

### BACKGROUND

Current commercially available picture frames mostly include a frame or moulding, a picture glass, a mat, a center space for placing a photo, and a backing board. Some picture frames may include a description or logo to indicate the occasion of the photo, for example, “Anniversary,” “Congratulations.” Parents of newborn babies have very limited choices in selecting a picture frame that may include any memorialized information about the new born. Even custom-made picture frames only include simple descriptions, for example, a name and a date.

It is therefore desirable to provide a picture frame that includes multiple descriptions and adjustable markers for marking the descriptions, and that provides advantages heretofore unknown in the art.

### SUMMARY OF THE INVENTION

A picture frame including descriptive indicia and adjustable markers for marking descriptions is provided. The picture frame includes a picture frame body having a picture window disposed in the center of the picture frame body. A plurality of descriptive borders is disposed at the periphery of the picture frame. The plurality of descriptive borders include indicia for indicating a name, a year of birth, a blood type, a weight, a height, a date of birth, and a horoscope sign. A plurality of adjustable markers are provided to be used with the descriptive borders to provide the information relating to the subject whose picture is displayed in the picture window.

In some implementations, the picture frame includes a picture frame body having a picture window disposed in the center of the picture frame body, the picture window including a backing board and a picture glass. The plurality of descriptive borders include a first descriptive border disposed outwardly from the picture window and including receptacles for receiving matching tiles, a first weight measurement indicia in metric system, a second weight measurement indicia in a system different from the metric system, a first height measurement indicia in metric system, and a second height measurement indicia in a system different from the metric system. A second descriptive border is disposed outwardly adjacent to the first descriptive border and including indicia for minutes. A third descriptive border is disposed outwardly adjacent to the second descriptive border and including indicia for hours. A fourth descriptive border is disposed outwardly adjacent to the third descriptive border, and a fifth descriptive border is disposed outwardly adjacent to the fourth descriptive border, the fourth descriptive border and the fifth descriptive border including indicia for dates. And a sixth descriptive border is disposed outwardly adjacent to the fifth descriptive border and including indicia for astrology. A plurality of adjustable markers are provided to be used with the descriptive borders to provide the information relating to the subject whose picture is displayed in the picture window.

Other devices, apparatus, systems, methods, features and advantages of the disclosure will be or will become apparent to one with skill in the art upon examination of the following figures and detailed description. It is intended that all such additional systems, methods, features and advantages be included within this description, and be protected by the accompanying claims.

### BRIEF DESCRIPTION OF THE FIGURES

The present invention may be better understood by referring to the following figures. The components in the figures are not necessarily to scale, emphasis instead being placed upon illustrating the principles of the disclosure. In the figures, like reference numerals designate corresponding parts throughout the different views.

FIG. 1 is a front perspective view of one example of a picture frame in accordance with the teachings of the present disclosure.

FIG. 2 is a rear perspective view of the picture frame of FIG. 1.

FIG. 3A is a top view of the picture frame of FIG. 1.

FIG. 3B is a top view illustrating a first descriptive border of the picture frame of FIG. 1.

FIG. 3C is a top view illustrating the first and second descriptive borders of the picture frame of FIG. 1.

FIG. 3D is a top view illustrating the first, second and third descriptive borders of the picture frame of FIG. 1.

FIG. 3E is a top view illustrating the first, second, third, fourth, and fifth descriptive borders of the picture frame of FIG. 1.

FIG. 3F is a top view illustrating the first, second, third, fourth, fifth, and sixth descriptive borders of the picture frame of FIG. 1.

FIG. 4A is a cross-sectional view taken along line 4-4 of the picture frame illustrated in FIG. 3A.

FIG. 4B is an enlarged partial cross-sectional view of the picture frame body illustrated in FIG. 4A.

FIG. 5 is a partially cross-sectioned exploded view of the picture frame of FIG. 1.

FIG. 6A is a first exploded view of a fixing corner of the picture frame of FIG. 1.

FIG. 6B is a second exploded view of a fixing corner of the picture frame of FIG. 1.

FIG. 7A is a top view of another example of a picture frame in accordance with the teachings of the present disclosure.

FIG. 7B is a top view illustrating a first descriptive border of the picture frame of FIG. 7A.

### DETAILED DESCRIPTION

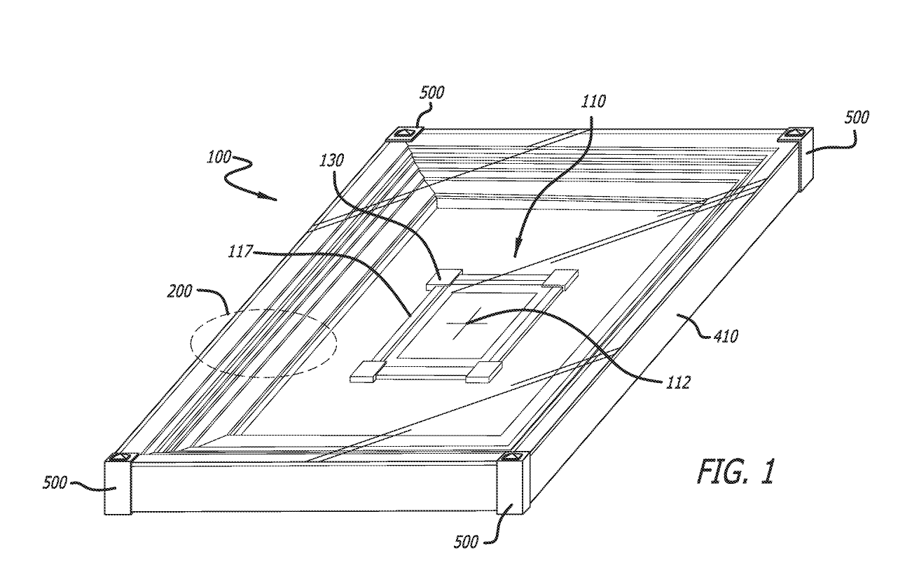

FIGS. 1-6 illustrate examples of various implementations of a picture frame that includes multiple descriptive borders having adjustable markers for marking the descriptions disposed in the descriptive borders. Generally, the picture frame includes a picture window disposed in the center of the picture frame, and the plurality of descriptive borders surrounding the picture window. The descriptive borders may include descriptions relating to the subject in the picture, for example, the name, birth date, blood type, weight, height (or length), and horoscope sign of a baby in the picture. The descriptive borders may also include markers that can be adjusted to indicate the descriptions of the subject. The picture frame may include fixing corners for coupling a frame glass to the frame body. In some implementations, the picture frame may include a rectangular shape. In other implementations, the picture frame may include a rectangular shape with four equal sides.

FIG. 1 is a front perspective view of one example of a picture frame 100 of the present invention. The picture frame 100 generally includes a frame body 410, a picture window 110 disposed in the center of the frame body 410 for receiving a picture, and a plurality of descriptive borders 200 surrounding the picture window 110. The frame body 410, the picture window 110, and the descriptive borders 200 may be constructed of any combination of plastic, polyvinyl chloride (PVC), aluminum, wood, ceramic, or any other suitable materials.

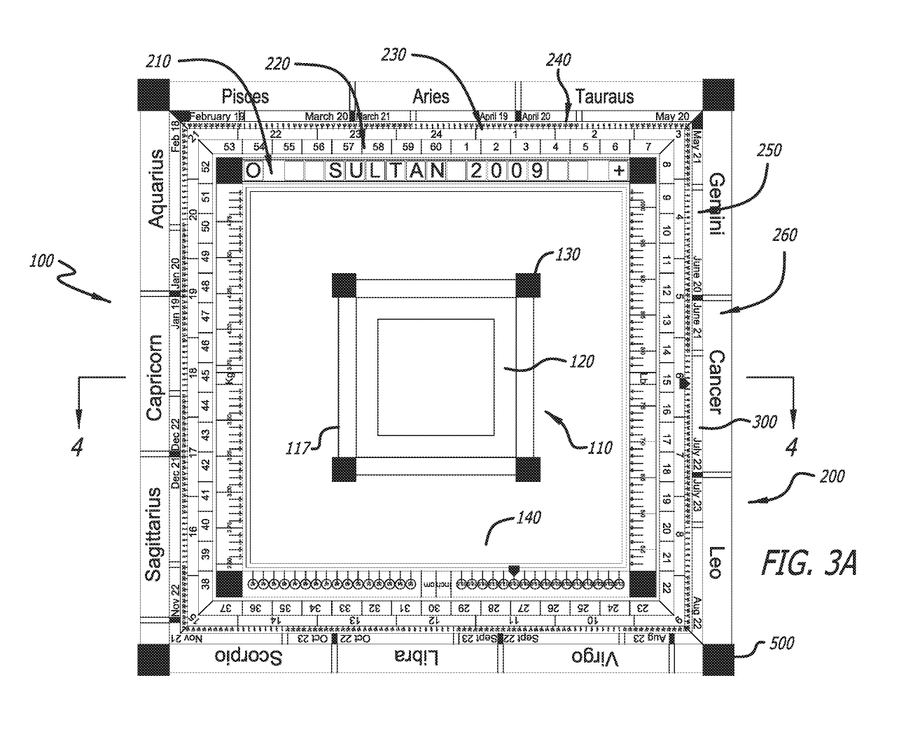

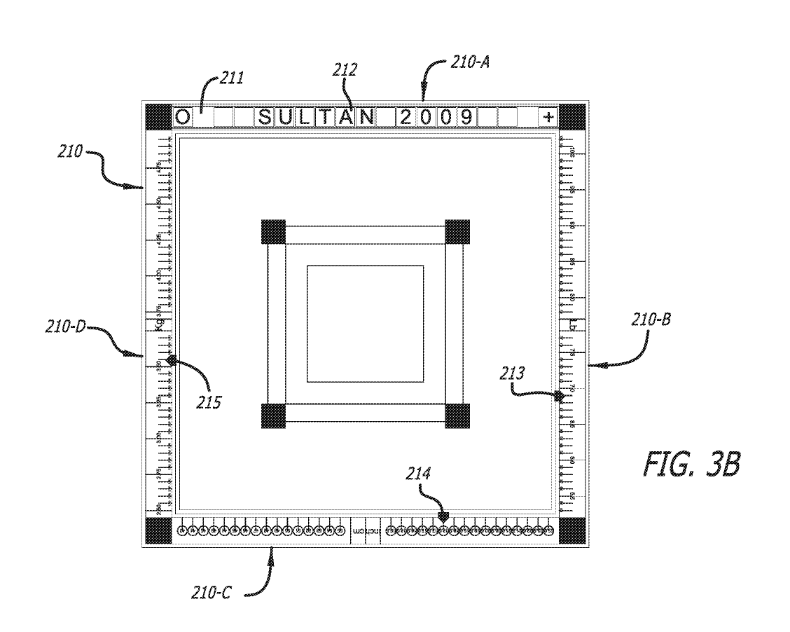

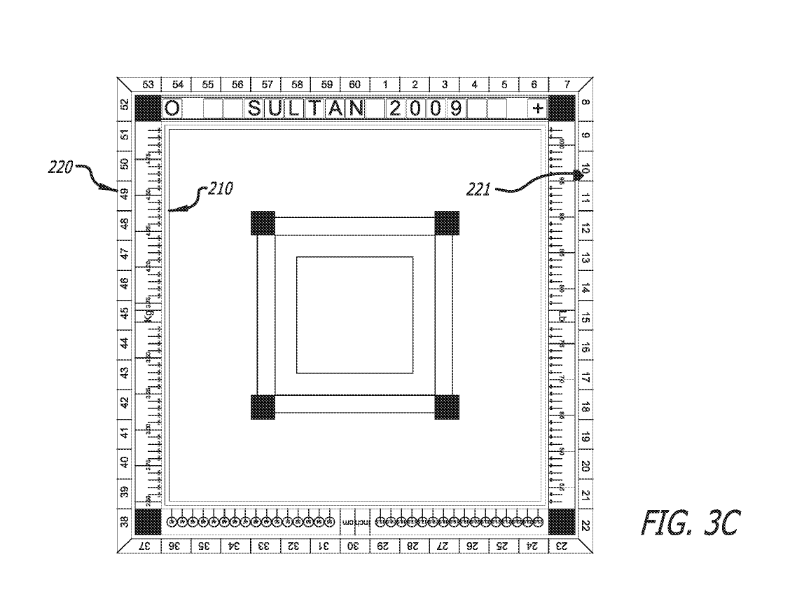

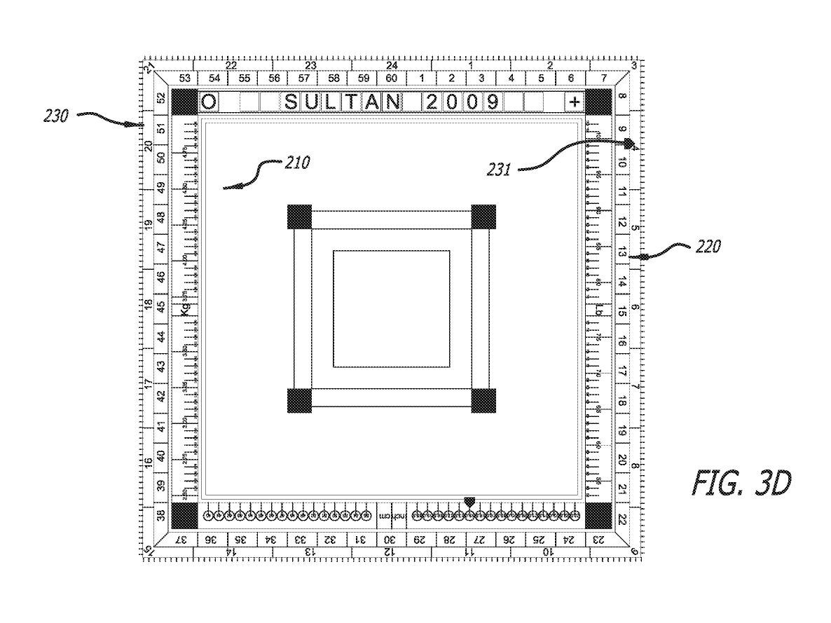

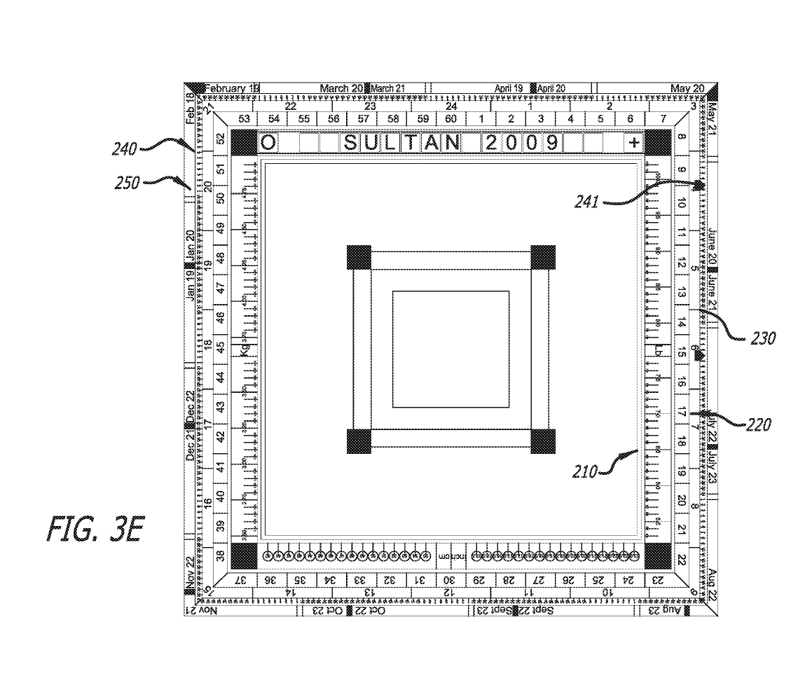

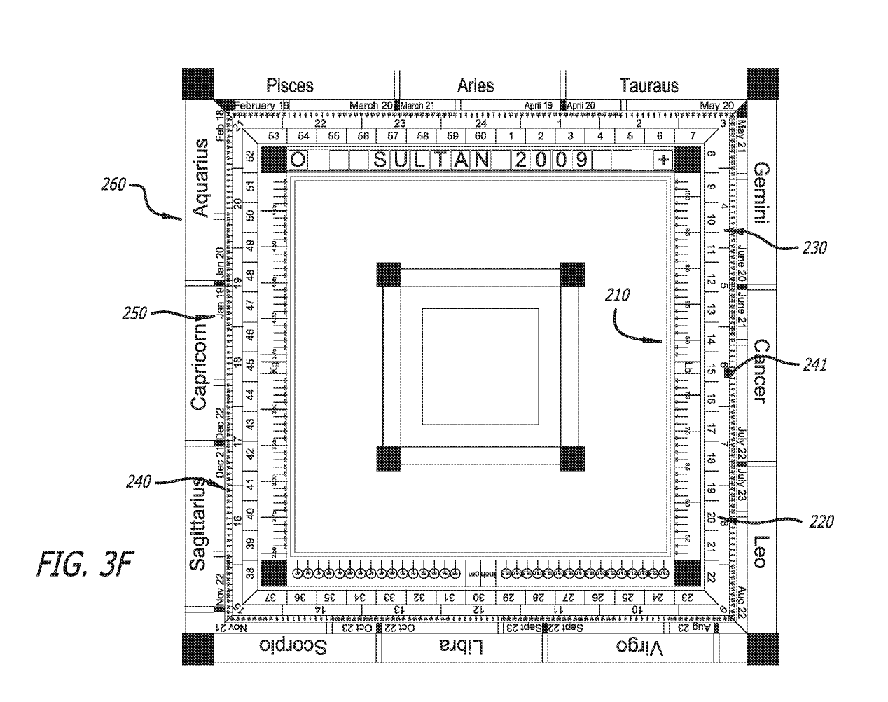

The plurality of descriptive borders 200 are preferably indexed or centered about a center axis 112 of the picture window 110. The descriptive borders 200 may include a plurality of descriptive indicia, or descriptions 300 (as illustrated in FIGS. 3A-3F) relating to the subject in the picture, for example, the name, birth date, blood type, weight, height (or length), and horoscope date and sign of the subject in the picture. The descriptive borders 200 may also include a plurality of markers 400 (as illustrated in FIGS. 3A-3F) that can be adjusted, for example, slid along the descriptions 300, to indicate the various descriptions of the subject. The picture frame 100 may include four fixing corners 500 for coupling a top frame glass to the frame body 410. The fixing corners 500 may be constructed of plastic, PVC, copper, aluminum, ceramic, or any other suitable materials.

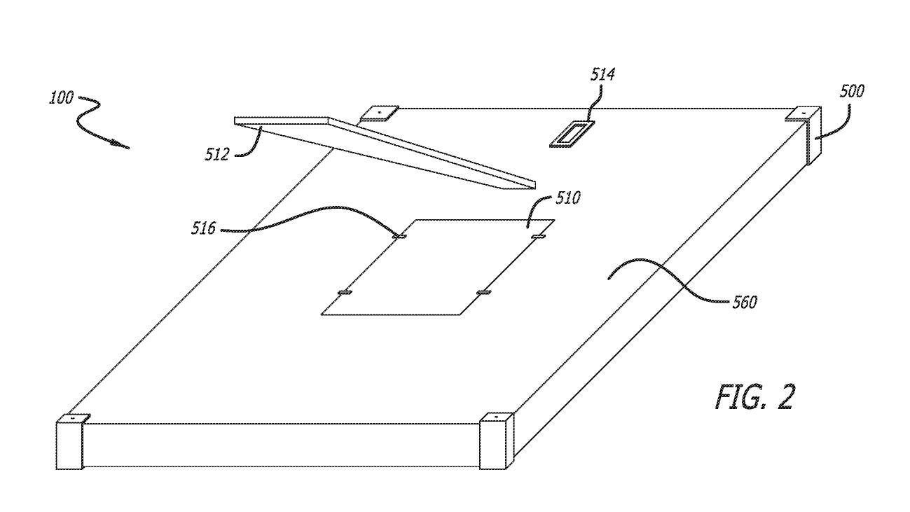

FIG. 2 illustrates a rear perspective view of the picture frame 100. A backing board 510, sized to cover the picture window 110, may be kept in place using multiple fasteners or clips 516. A stand 512 may be included for displaying the picture frame 100 in an easel-form display. The backing board 510 and stand 512 may be constructed of any combination of cardboard, plastic, aluminum, ceramic, or other suitable materials. In some implementations, the backing board 510 may be coated with a finish that compliments the finish of the picture frame 100.

A hanging, or mounting hook 514 may be included for hanging the picture frame 100 on a vertical surface, such as a wall. In some implementations, the hanging hook 514 may be a rectangular indent. In some exemplary operations, the backing board 510 may be temporarily removed so that a picture may be placed in the picture window 110. The backing board 510 may be removed by rotating the clips 516 outwardly, out of engaging contact with the backing board 510.

FIG. 3A illustrates a top view of the picture frame 100. As shown, the picture frame 100 includes the picture window 110, formed by an inner frame 117, for receiving and displaying a picture. As described herein, a backing board 510 may be disposed at the rear of the picture window 110 for placing and removing a picture. One or more mat boards 120 may be disposed within the inner frame 117 atop the picture and the backing board 510 when the picture is placed in the picture window 110. The mat boards 120 may include windows or openings, of varying dimensions, through which the picture may be viewed. The mat boards 120 may be constructed of cardboard, felt, wood, PVC, or any other suitable materials. In most implementations, the picture frame 100 further includes a frame surface 140 disposed between the picture window 110 and an innermost descriptive border.

Turning our attention back to the picture window 110, the inner frame 117 may be secured or otherwise held together by four securing posts 130. The securing posts 130 may be constructed of plastic, PVC, wood, aluminum, ceramic, or other suitable materials. In some implementations, each securing post 130 may be coupled or otherwise attached to a frame surface 140 by, for example, an adhesive or fasteners. In other implementations, the securing post 130 may be integrally formed with the frame surface 140.

In some implementations, the inner frame 117 and a picture glass 115 may be disposed on top of the mats 120. In some implementations, the post 130 may, further, secure the picture glass 115 and the inner frame 117 together with the mats 120.

As described herein, the picture frame 100 includes a plurality of descriptive borders 200 disposed at the periphery of the picture frame 100. The descriptive borders 200 provide information about the subject of the picture. For example, in some implementations described herein, the descriptive borders 200 provide information about an infant's birth. In some other implementations, also described herein, the descriptive borders 200 provide information about a pet.

In particular, as shown, the descriptive borders 200 may include, for example, an innermost or first descriptive border 210 for displaying, for example only, the name, year of birth, blood type, and measurements in weight and height (or length) of the subject of the picture. A second descriptive border 220 may be disposed outwardly adjacent to the first descriptive border 210 for indicating, for example only, the minute in which the subject of the picture was born. A third descriptive border 230 may be disposed outwardly adjacent to the second descriptive border 220 for indicating, for example only, the hour in which the subject of the picture was born.

A fourth descriptive border 240 may be disposed outwardly adjacent to the third descriptive border 230 for indicating, for example only, the day in which the subject of the picture was born. A fifth descriptive border 250 may be disposed outwardly adjacent to the fourth border 240 for indicating, for example only, the month in which the subject of the picture was born. And an outermost or sixth descriptive border 260 may be disposed outwardly adjacent to the fifth descriptive border 250 for indicating, for example only, a horoscope indicia. FIGS. 3B to 3F illustrate exemplary implementations of the descriptive borders 200 in more detail.

Turning now to FIG. 3B, a top view of one example of the first descriptive border 210 is illustrated. In some implementations, the first descriptive border 210 includes four sides 210-A to 210-D.

The first side 210-A may include a mechanism for indicating the name, year born, and blood type of the subject of the picture. In some implementations, the side 210-A includes rectangular receptacles 211 for receiving matching rectangular tiles 212 embossed or otherwise marked with alphanumeric characters.

In the example shown, the tiles 212 may be placed into the receptacles 211 to form, for example, the name (e.g., shown as “SULTAN” in FIG. 3B), year of birth (e.g., “2009” as shown), and blood type (e.g., “0” “+” as shown) of the subject of the picture. In some implementations, the tiles 212 and receptacles 211 may be constructed to corresponding square shapes, however, in other implementations, they may be constructed to other corresponding geometric shapes.

The tiles 212 may be sized to fit into the receptacles 211 and may be included as part of the picture frame 100. It should be noted that the tiles 212 may be secured from falling out of the receptacles 211 by magnetic coupling (e.g., coupling a positive pole magnet affixed to a rear surface of the tiles with a negative pole magnet affixed to an inner surface of the receptacle), an adhesive, hook-and-loop (e.g., Velcro®) coupling, or by other suitable means.

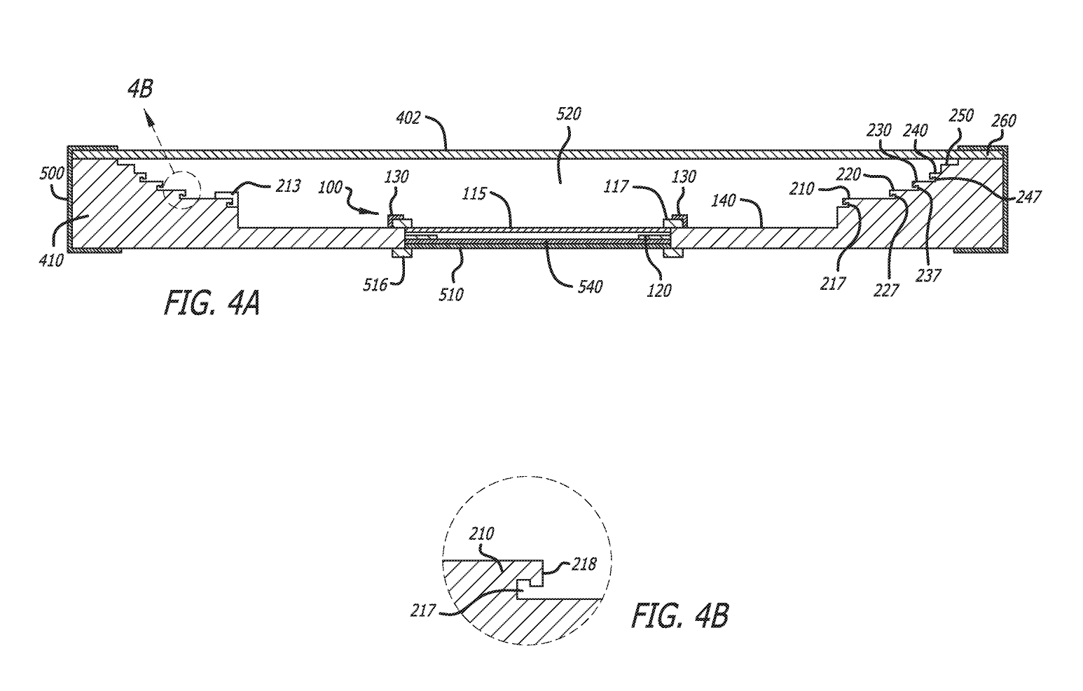

A second side 210-B of the first descriptive border 210 may be pre-marked with measurements indicia to indicate a weight in British or American systems (e.g., in pounds). In some implementations, the side 210-B may be marked with measurements from, for example, 5 to 10.5 pounds (lbs). A slidable marker 213 may be provided for adjustably marking an approximate weight of the subject in the picture. The slidable marker 213 may be slid along the inside length of the side 210-B. As shown in FIG. 4, the picture frame 100 may include rails 217 for receiving the slidable markers 213 and supporting the sliding movement thereof.

Turning back to FIG. 3B, a third side 210-C of the border 210 may be pre-marked with measurements indicia to indicate a height (or length) in either metric (e.g., in centimeters), or British or American (e.g., in inches) systems, or in both systems. In some implementations, the side 210-B may be marked with measurements from, for example, 15 to 23 inches (in.), and from 40 to 55 centimeters (cm). A slidable marker 214 may be provided for adjustably marking an approximate height (or length) of the subject in the picture. The slidable marker 214 may be slid along the inside length of the side 210-C.

A fourth side 210-D of the border 210 may be pre-marked with measurements indicia to indicate a weight in metric system (e.g., in kilograms). In some implementations, the side 210-D may be marked with measurements from, for example, 2.5 to 5 kilograms (Kg). A slidable marker 215 may be provided for adjustably marking an approximate weight of the subject in the picture. The slidable marker 215 may be slid along the inside length of the side 210-D.

FIG. 3C is a top view of the second descriptive border 220. The second descriptive border 220 is outwardly adjacent to the first descriptive border 210. In some implementations, the border 220 includes four sides pre-marked with indicia to indicate the minutes when the subject in the picture was born. For example, the border 220 may be marked with numbers from “1” to “60” to indicate the 60 minutes in an hour. A slidable marker 221 may be provided for adjustably marking an approximate minute when the subject in the picture was born. The slidable marker 221 may be slid along the inside length of all four sides of the border 220.

Turning now to FIG. 3D, the third descriptive border 230 is shown. The third descriptive border 230 is outwardly adjacent to the descriptive border 220. In some implementations, the border 230 includes four sides pre-marked with indicia to indicate the hour when the subject in the picture was born. For example, the border 230 may be marked with numbers from “1” to “24” to indicate the 24 hours in a day. A slidable marker 231 may be provided for adjustably marking an approximate hour when the subject in the picture was born. The slidable marker 231 may be slid along the inside length of all four sides of the border 230.

FIG. 3E is a top view of the fourth descriptive border 240 and the fifth descriptive border 250. The fourth descriptive border 240 is outwardly adjacent to the third descriptive border 230. The fifth descriptive border 250 is outwardly adjacent to the fourth descriptive border 240.

In some implementations, the fourth descriptive border 240 may include four sides pre-marked with indicia to indicate the date when the subject in the picture was born. For example, the fourth descriptive border 240 may be marked with twelve sets of numbers from “1” to “31” to indicate the maximum number of days in a month, for each of the twelve months in a year. In some implementations, some sets may have less than 31 numbers.

In some implementations, the fifth descriptive border 250 may include four sides pre-marked with the months in a year. In some implementations, the marking of the months may not start from the first day of the month, e.g., January 1. Instead, the marking of the months may start in a way to approximately coincide with an astrological or horoscope calendar, for example, January 20 to February 18, February 19 to March 20, and so on, to approximately coincide with the Western astrology. It should be noted that different descriptive borders for different systems of astrology or horoscope may be provided. As the fourth descriptive border 240 (date) and the fifth descriptive border 250 (month) are used together, a slidable marker 241 may be provided for adjustably marking an approximate date when the subject in the picture was born. For example, FIG. 3E shows the descriptive border 250 having the months coincide with the Western astrology, and the marker 241 at approximately June 5. The slidable marker 241 may be slid along the inside length of all four sides of the border 240.

Turning to FIG. 3F, the sixth descriptive border 260 is illustrated. The sixth descriptive border 260 is outwardly adjacent to the fifth descriptive border 250. In some implementations, the sixth descriptive border 260 includes four sides pre-marked with indicia to approximately indicate the signs of the astrology system used in the descriptive border 250. For example, FIG. 3F shows the Western astrology (e.g., Pisces, Aries, and so on) to approximately coincide with the months in the descriptive border 250 (e.g., February 19 to March 20, March 21 to April 19, and so on). In these implementations, the marker 241 not only indicates the date of birth, but also the astrological or horoscope sign of the subject in the picture.

The various markings described above may be imprinted, engraved, debossed or embossed into the sides of the descriptive borders 210, 220, 230, 240, 250, and 260.

FIG. 4A is a cross-sectional view of the picture frame 100. In some implementations, as shown, the picture frame 100 may include a frame body 410. The frame body 410 may include an interior frame surface 140 and the descriptive borders 210, 220, 230, 240, 250 and 260 integrally formed into the frame body 410.

The descriptive borders 210, 220, 230, and 240 may include corresponding rails 217, 227, 237, and 247 formed on their undersides. The rails 217, 227, 237, and 247 may be sized to receive corresponding slidable markers 213, 214, 215, 221, 231, 241 (FIGS. 3B-3E). As shown, each descriptive border 210, 220, 230, 240, 250, 260 may be offset from an adjacent border in an ascending stair-step fashion, where the sixth descriptive border forms the top surface or face of the frame body 410.

FIG. 4B is an enlarged partial cross-sectional view of the frame body 410. As best shown, each rail, for example, rail 217 may be defined by an L-shape lip 218 outwardly extending from a cantilevered portion or edge of a descriptive border, which in the example shown is descriptive border 210. Each corresponding slidable marker, for example, slidable marker 213 may have a corresponding L-shape lip adapted and sized to slidably fit into and translate within, for example, rail 217.

Referring back to FIG. 4A, a frame glass 402 may rest atop the sixth descriptive border 260. In other implementations, the frame glass 402 may be constructed of plexiglass, plastic, or other suitable optically clear material. As shown, the frame glass 402 may be coupled to the frame body 410 by the fixing corners 500.

It should be noted that although the frame body 410 is shown as a single structure including the frame surface 140 and the descriptive borders 210, 220, 230, 240, 250 and 260, the descriptive borders 210, 220, 230, 240, 250 and 260 may also be separate parts coupled to the frame surface 140 to form the frame body 410. It should also be noted that although the descriptive borders 210, 220, 230, 240, 250 and 260 are shown being offset from or having different elevations relative to the frame surface 140, it is also contemplated that some or all of the descriptive borders may have the same elevation.

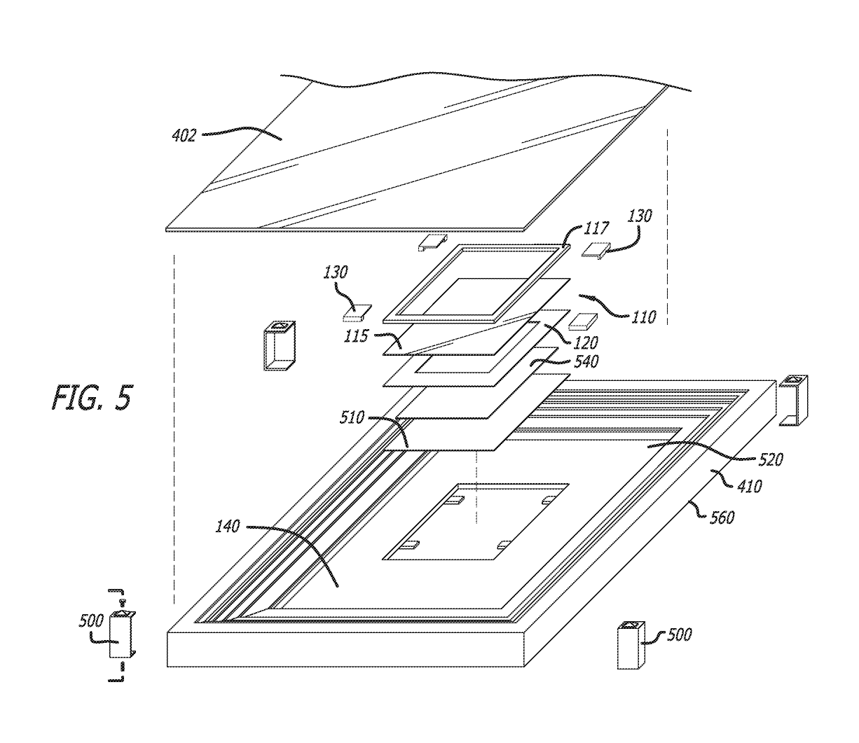

FIG. 5 is a partial cross-sectioned exploded view illustrating how the picture frame 100 may be assembled together. As shown, the frame glass 402 may be coupled to the top surface or face of the frame body 410, by one or more fixing corners 500, to form a sealed enclosure 520 (see also FIG. 4A) therebetween.

The picture window 110 is disposed within the sealed enclosure 520 and, further, may include the picture glass 115 and the inner frame 117 coupled to the frame surface 140. The inner frame 117 is adapted to receive and retain the picture glass 115, a border mat(s) 120, and the subject picture 540. The border mat 120 defines the outer border of the subject picture 540. As further shown, the backing board 510 may be removeably coupled to a rear surface 560 (see also FIG. 2) of the frame body 410 to permit the picture glass 115, the border mat(s) 120, and the subject picture 540 to be secured within or removed from the picture window 110.

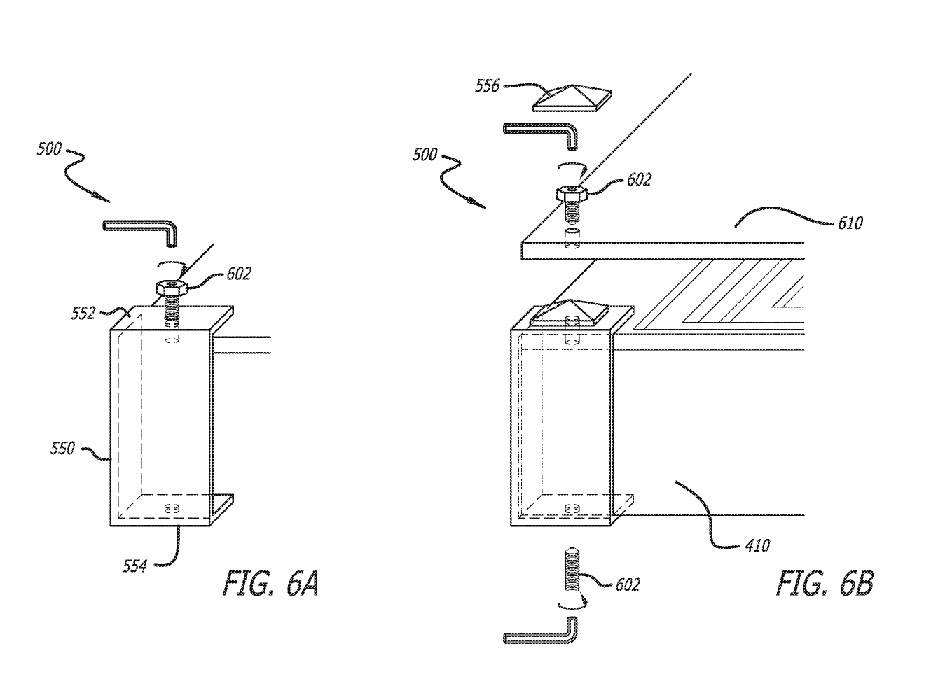

FIGS. 6A and 6B are exploded views of one example of the fixing corner 500. As shown in FIG. 6A, each fixing corner 500 includes a top plate 552, a bottom plate 554 and two upstanding walls 550 extending therebetween, where the walls 550 are adapted to abut the corresponding outside corner surfaces of the frame body 410 when the fixing corner 500 is used to couple the frame glass 402 to the frame body 410. The fixing corner 500 may be attached to the frame body 410 using a pair of fasteners 602, for example, screws at the top plate 552 and bottom plate 554 as shown. In other implementations, the fixing corners 500 may attached to the frame body by an adhesive, press or interference fit, or other suitable means. In some implementations, as shown in FIG. 6B, the fixing corner 500 may further include caps 556 used to cover the top plates 552 for decorative purpose.

Referring to FIGS. 1, 2, 3A, and 5, upon assembly, the user may place tiles 212 into the receptacles 211 of the first descriptive border 210 to indicate, for example, the name, year of birth, and blood type of the subject of the picture. Next, the user may slidably adjust the slidable markers 213, 214, 215, 221, 231, 241 to locations relative to the descriptive borders 210, 220, 230, 240, 250 and 260 to indicate, for example, measurements, such as the height, weight, time, and date of birth of the subject of the picture. Once the various descriptions and measurements of the subject are set, the user may fasten the inner frame 117 to the frame surface 140 and secure the frame glass 402 to the frame body 410, via the fixing corners 500, to enclose the descriptive borders 210, 220, 230, 240, 250, 260 and picture window 110. Once the frame glass 402 is secured, the user may turn the picture frame 100 on its front face, unlatch and remove the backing board 510 from the rear surface 560 of the frame body 410, and install the picture glass 115, the border mat(s) 120, and the subject picture 540 within the picture window 110. In some implementations, a mount board (not shown) may also be installed after the subject picture 540 center and/or further support the subject picture 540 within the picture window 110. After the installation of the subject picture 540, the backing board 510 may be re-attached to the rear surface 560 of the frame body 410, and the picture frame 100 may either be hung from the mounting hook 514 or sat upright on a surface via the stand 512.

Referring back to FIG. 1, in some implementations, the picture frame body 410 may have a square shape with each side being approximately 451 millimeters in length. The picture window 110 may correspond in shape with the picture frame body 410 (i.e., square shape), with each side being approximately 120 millimeters in length. The picture frame body 410 may, further, have a height of 43 millimeters. While the picture frame 100 disclosed herein is described as having a square shape, those skilled in the art will appreciate that the picture frame and corresponding picture window may be constructed to any geometrical shape and dimensions.

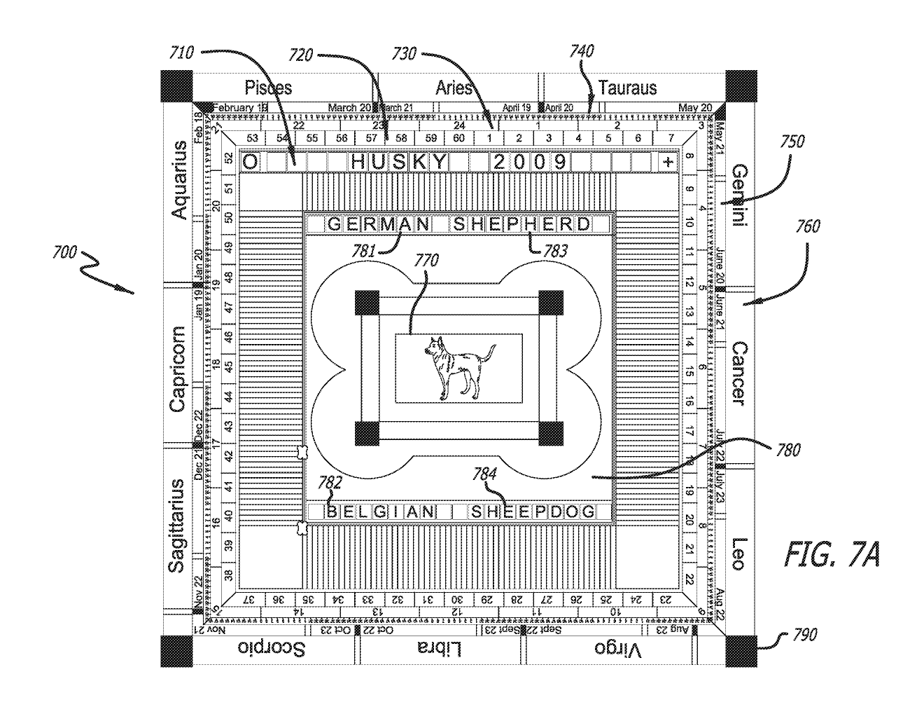

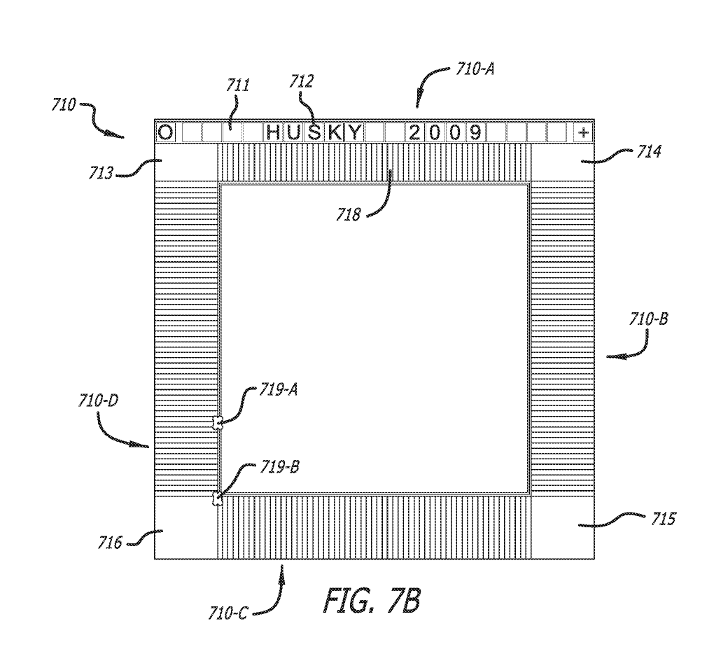

Turning to FIGS. 7A and 7B, another exemplary implementation of the picture frame of the present invention is illustrated. As described herein, in some implementations, one or more descriptive borders of the picture frame may provide information about a pet, for example, a dog or a cat. Further detail of this exemplary implementation will be described below.

FIG. 7A shows a top view of a picture frame 700 adapted to provide information about, for example only, a dog. The picture frame 700 may include a picture window 770 which may be substantially similar to the picture window 110 of picture frame 100. The picture window 770 may receive a picture of a pet in substantially the same manner as a picture is installed in the picture window 110 as described herein. The picture frame 700 may also include a plurality of descriptive borders 710, 720, 730, 740, 750 and 760.

To provide information about a pet, in this implementation, for example, the innermost or first descriptive border 710 may be adapted to indicate, for example only, the name, year of birth, blood type, and breed of the pet. The second, third, fourth, fifth and sixth descriptive borders 720, 730, 740, 750 and 760 may include descriptive attributes similar to those of the second, third, fourth, fifth and sixth descriptive borders 220, 230, 240, 250 and 260 of picture frame 100 described herein.

Turning now to FIG. 7B, a top view of one example of the first descriptive border 710 is illustrated. In some implementations, the first descriptive border 710 includes four sides 710-A to 710-D.

The first side 710-A may include a mechanism for indicating the name, year born, and blood type of the pet in the picture. In some implementations, the side 710-A includes rectangular receptacles 711 for receiving matching rectangular tiles 712 embossed or otherwise marked with alphanumeric characters. In the example shown, the tiles 712 may be placed into the receptacles 711 to form, for example, the name (e.g., shown as “HUSKY”), year of birth (e.g., “2009” as shown), and blood type (e.g., “0” “+” as shown) of the pet in the picture. In some implementations, the tiles 712 and receptacles 711 may be constructed to corresponding square shapes, however, in other implementations, they may be constructed to other corresponding geometric shapes. The tiles 712 may be sized to fit into the receptacles 711 and may be included as part of the picture frame 700. It should be noted that the tiles 712 may be secured from falling out of the receptacles 711 by magnetic coupling, an adhesive, hook-and-loop (e.g., Velcro®) coupling, or by other suitable means.

The descriptive border 710 may also include indicia 718 for indicating the breed of the pet in the picture. In the example shown, the indicia 718 may be provided at all four sides 710-A, 710-B, 710-C and 710-D. The descriptive border 710 may include at least one slidable marker 719-A to indicate the breed. The slidable marker 719-A may be slid along the inside length of all four sides 710-A, 710-B, 710-C and 710-D. In the example shown, two markers 719-A and 719-B are provided. The two markers 719-A and 719-B may be positioned at two different breed indicia to indicate a mixed or crossed breed from the two indicated breeds. When the pet is not a mixed or crossed breed, one of the two markers 719-A and 719-B may be positioned to a blank indicia on the descriptive border 710. It is noted that the markers 719-A and 719-B may be constructed with decorative shapes or figures. In the example shown, the adjustable markers 719-A and 719-B have the shape and figure of a bone.

The descriptive border 710 may also include one or more receptacles to receive additional pictures of the pet. In the example implementation, the descriptive border 710 includes four picture receptacles 713, 714, 715 and 716 positioned at the four corners of the descriptive border 710. The dimensions of the picture receptacles 713, 714, 715 and 716 correspond to the dimensions, for example, the width, of the descriptive border 710. The picture receptacles 713 and 714 may be smaller than the picture receptacles 715 and 716 to provide space for the receptacles 711 described herein. The additional pictures may be secured from falling out of the receptacles 713, 714, 715 and 716 by magnetic coupling, an adhesive, hook-and-loop (e.g., Velcro®) coupling, or by other suitable means.

Turning back to FIG. 7A, the picture frame 700 includes the frame surface 780. The frame surface 780, in the example shown, may include rectangular receptacles 781 and 782 for receiving matching rectangular tiles 783 and 784 embossed or otherwise marked with alphanumeric characters. In the example shown, the tiles 783 may be placed into the receptacles 781 to form, for example, the breed (e.g., shown as “GERMAN SHEPHERD”) of the pet in the picture. The tiles 784 may be placed into the receptacles 782 to form, for example, the variety breed, or the second breed of a mixed or crossed breed (e.g., shown as “BELGIAN SHEEPDOG”) of the pet in the picture(s). It is noted that the above uses of the receptacles 781 and 782 are only examples. The receptacles 781 and 782 may be used for any suitable descriptions of the pet in the picture(s). The tiles 783 and 784 may be secured from falling out of the receptacles 781 and 782 respectively by magnetic coupling, an adhesive, hook-and-loop (e.g., Velcro®) coupling, or by other suitable means.

In some implementations, as shown in FIG. 7A, the frame surface 780 may include, for example, printed or embossed thereon, decorative indicia (e.g., as shown with a decorative bone figure). In some implementations, the fixing corners 790 may also include decorative indicia, for example, printed or embossed on the caps of the fixing corners 790.

In general, terms such as “coupled to,” and “configured for coupling to,” and “secured to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

Although the previous description illustrates particular examples of various implementations, the present disclosure is not limited to the foregoing illustrative examples. A person skilled in the art is aware that the disclosure as defined by the appended claims and their equivalents can be applied in various further implementations and modifications. In particular, a combination of the various features of the described implementations is possible, as far as these features are not in contradiction with each other. Accordingly, the foregoing description of implementations has been presented for purposes of illustration and description. Modifications and variations are possible in light of the above description.

1. A picture frame with a plurality of descriptive borders and a plurality of adjustable markers, comprising:
a picture frame body;
a picture window disposed in the center of the picture frame body, the picture window including a backing board and a picture glass;
a first descriptive border disposed outwardly from the picture window, the first descriptive border including receptacles for receiving matching tiles, a first weight measurement indicia in metric system, a second weight measurement indicia in a system different from the metric system, a first height measurement indicia in metric system, and a second height measurement indicia in a system different from the metric system;
a second descriptive border disposed outwardly adjacent to and concentric with the first descriptive border, the second descriptive border including indicia for minutes;
a third descriptive border disposed outwardly adjacent to and concentric with the second descriptive border, the third descriptive border including indicia for hours;
a fourth descriptive border disposed outwardly adjacent to and concentric with the third descriptive border, and a fifth descriptive border disposed outwardly adjacent to and concentric with the fourth descriptive border, the fourth descriptive border and the fifth descriptive border including indicia for dates; and
a sixth descriptive border disposed outwardly adjacent to and concentric with the fifth descriptive border, the sixth descriptive border including indicia for astrology.

2. The picture frame of claim 1, wherein one or more of the plurality of descriptive borders includes one or more rails.

3. The picture frame of claim 2, wherein one or more of the plurality of adjustable markers may be adjustably slid along the one or more rails.

4. The picture frame of claim 1, wherein each receptacle is adapted to receive a matching tile pre-marked with alphanumeric characters.

5. The picture frame of claim 4, wherein the tiles are used for indicating a name, a year of birth, and a blood type.

6. The picture frame of claim 1, wherein the receptacles and the matching tiles are in rectangular shape.

7. The picture frame of claim 1, wherein the receptacles and the matching tiles are in square shape.

8. The picture frame of claim 1, wherein the second weight measurement indicia is British or American system.

9. The picture frame of claim 1, wherein the second height measurement indicia is British or American system.

10. The picture frame of claim 1, wherein the dates coincide with an astrological or horoscope calendar.

11. The picture frame of claim 1 further comprising a plurality of fixing corners for coupling a frame glass to the picture frame body.

12. The picture frame of claim 1 further comprising one or more mat boards disposed between the backing board and the picture glass.

13-15. (canceled)

16. A frame for a picture comprising:
a frame body;
a picture window disposed in the center of the picture frame body; and
a plurality of concentrically arranged descriptive borders disposed at the periphery of the frame.

17. The frame of claim 16 further including a picture glass secured to an open end of the frame, the picture glass enclosing the picture window and the at least one descriptive border.

18. The frame of claim 16, wherein the plurality of descriptive borders include indicia for indicating at least one of a name, a year of birth, a blood type, a weight, a height, a date of birth, and a horoscope sign.

19. The frame of claim 16 further comprising a plurality of adjustable markers coupled to the plurality of descriptive borders, the adjustable markers being adjustable to correspond to the indicia on the at least one descriptive border to identify an attribute of the subject in the picture.

20. The frame of claim 16, wherein the picture window is adapted to removably house the picture.

21. The frame of claim 1, wherein each descriptive border may be offset from an adjacent descriptive border in an ascending stair-step fashion, where the sixth descriptive border forms the top surface or face of the frame body.

22. The frame of claim 18, wherein each descriptive border may be offset from an adjacent descriptive border in an ascending stair-step fashion, where the sixth descriptive border forms the top surface or face of the frame body.
